(19) United States
(12) Patent Application Publication
(10) Pub. No.: US 2012/0261464 A1
(43) Pub. Date: Oct. 18, 2012

(54) PAPER CONTAINER AND METHOD OF MAKING THE SAME

(76) Inventor: Chi-Jui HUNG, Taichung City (TW)

(21) Appl. No.: 13/085,270

(22) Filed: Apr. 12, 2011

(51) Int. Cl. B65D 3/00; B29C 45/14

(52) U.S. Cl. 229/400; 264/257; 264/478

(57) ABSTRACT

The present invention provides a paper container and a method of making the same. The method comprises the steps of preparing a mold; sending paper into the mold; injecting plastic material after closing the mold; and opening the mold to acquire a paper container. Thereby, the plastic material can be connected between two distal ends of the paper. So the connection part of the paper is smooth and flat without any bumps, and the paper container has a good waterproof structure.

### BACKGROUND OF THE INVENTION

1. Field of the Invention

The present invention relates to a paper container and a method of making the same.

2. Description of the Prior Art

A conventional paper container is used for containing drinks, soups or other liquid. The paper container is made by overlapping and pasting two ends of paper which is coated with a waterproof film. As such, the paper is then formed in a loop, and then the top periphery of the paper is bent outwardly so as to form as a lip: The bottom of the paper is covered and sealed with another paper so as to from as a bottom portion, and then a conventional paper container is thereby obtained.

However, the lip of the paper container has an uneven part which is formed by two ends of the paper overlapping each other, so a lid or a film cannot completely cover and attach to the lip but form with a slit. Therefore, the liquid of the paper container may leak out from the slit. Furthermore, the paper container is mainly formed by two ends of the paper overlapping and pasting side by side, so the two ends of the paper respectively are exposed inside or outside the paper container. But the ends of the paper often are uncoated with the waterproof film, and liquid inside of the paper container may permeate the ends to wet the whole paper container. The paper container is easy to be damp and getting soft when the paper container contains liquid for a period of time.

Therefore, the present invention is arisen to obviate or at least mitigate the above mentioned disadvantages.

### SUMMARY OF THE INVENTION

The main object of the present invention is to provide a paper container and a method of making the same, wherein the paper container is mainly formed by two ends of paper smoothly and evenly connecting to each other so as to have a good waterproof structure, and the paper container can be completely covered with a lid or a film.

To achieve the above and other objects, the present invention provides a method of making a paper container. The method includes the following steps.

Firstly, prepare a mold which comprises a female mold, a male mold, and an injection hole. The female mold has a recess and an annular trough. The recess has at least one wall surface and a bottom surface. The male mold is correspondingly formed with at least one side wall and a bottom wall. The annular trough is formed on a top periphery of the recess, and the injection hole extends from the bottom surface or the bottom wall to an external space so as to communicate between the recess and the external space.

Secondly, send paper which is cut in a predetermined shape into the female mold. At least one surface of the paper is coated with a waterproof film. The paper has a first end and a second end. Make the paper annularly abut against the wall surface, so that the first end and the second end are close to each other to form a gap between them.

Thirdly, close the mold so as to make the paper abut against between the wall surface and the side wall. An injection space is defined between the bottom surface and the bottom wall. The injection space communicates between the gap and the injection hole. The gap communicates with the annular trough.

Fourthly, inject plastic material into the injection hole, and the plastic material fills up the injection space, flows into the gap, and then flows into the annular trough, so that the plastic material is connected between the first end and the second end. At last, open the mold to acquire a paper container.

Thereby, the present invention provides the method of connecting the first end to the second end with the plastic injection molding, so the plastic material can evenly and smoothly connected between the first and the second end of the paper so as to obtain the paper container having a good waterproof structure. Moreover, the top periphery of the paper container is also formed with the plastic material, so the top periphery is even and flat. A lid or film can thereby evenly abut against the top periphery so as to completely seal and cover an opening of the paper container.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a flow chart showing a method of making a paper container of the present invention;

FIG. 2 is a schematic drawing showing a method of making a paper container of the present invention, wherein the male mold and the female mold are separated;

FIG. 3 is a schematic drawing showing a method of making a paper container of the present invention, wherein the mold is closed;

FIG. 4 is the stereogram showing a paper container of the present invention;

FIG. 5 is a sectional drawing showing a part of a paper container of the present invention;

FIG. 5A is an enlarged drawing showing a part of a paper container of the present invention.

### DETAILED DESCRIPTION OF THE PREFERRED EMBODIMENTS

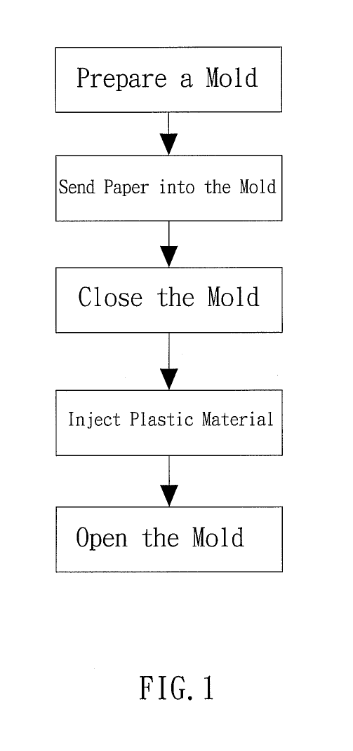

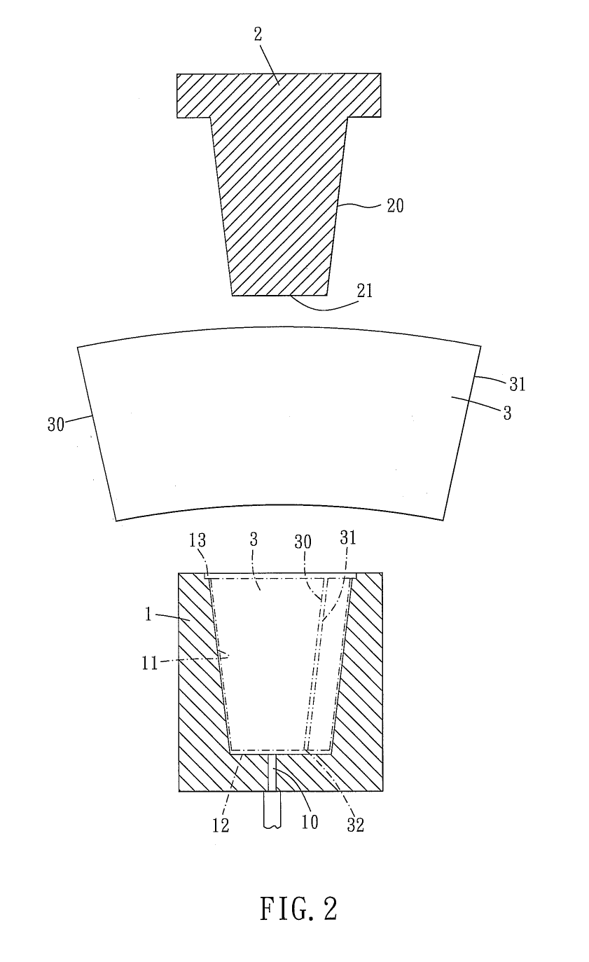

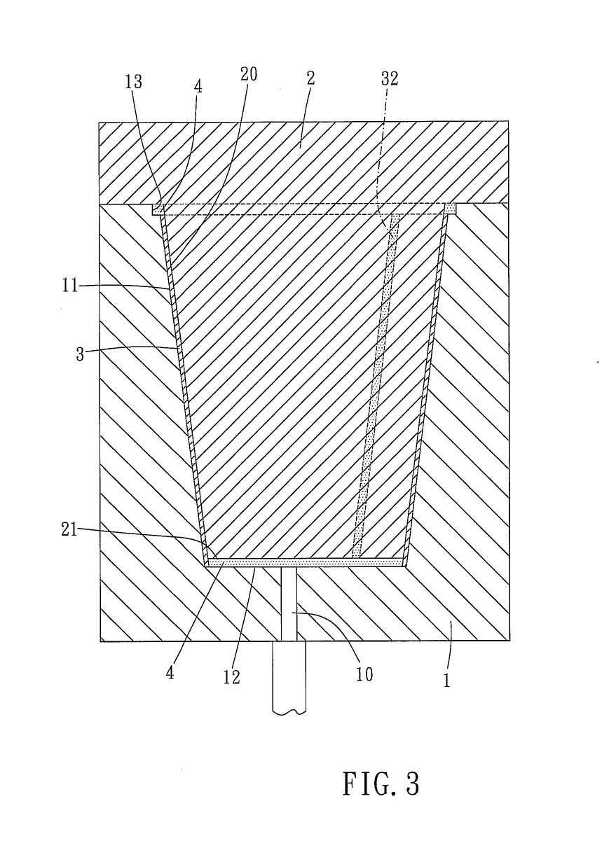

Please refer to FIGS. 1 to 3. The present invention provides a method of making a paper container. The method comprises the following steps.

At first, prepare a mold, and the mold comprises a female mold 1, a male mold 2, and an injection hole 10. The female mold 1 has a recess and an annular trough 13. The recess has at least one wall surface 11 and a bottom surface 12. Corresponding to the shape of the recess, the male mold 2 is formed with at least one side wall 20 and a bottom wall 21. The annular trough 13 is formed on a top periphery of the recess, and the injection hole 10 extends from the bottom surface 12 or the bottom wall 21 to an external space so as to communicate between the recess and the external space.

Secondly, send paper 3 which is cut in a predetermined shape into the female mold 3, wherein at least one surface of the paper 3 is coated with a waterproof film, and the paper has a first end 30 and a second end 31. Make the paper 3 annularly abut against the wall surface 11, so that the first end 30 and the second end 31 are close to each other to form a gap 32 between them.

Thirdly, close the mold to make the paper 3 abut against between the wall surface 11 and the side wall 20. An injection space is defined between the bottom surface 12 and the bottom wall 21. The injection space communicates between the gap 32 and the injection hole 10. The gap 32 communicates with the annular trough 13.

Fourthly, inject plastic material 4 into the injection hole 10 to make the plastic material 4 fill up the injection space, then flow into the gap 32, and then flow into the annular trough 13, so that the plastic material 4 is connected between the first end 30 and the second end 31.

At last, open the mold to acquire a paper container.

Specifically, in the second step, the paper 3 is sucked with a mechanical arm which has a vacuum suction apparatus, and the mechanical arm sends the paper 3 into the recess of the female mold 1. Preferably, the paper is electrified before sending it into the recess. The mechanical arm stops sucking the paper 3 once the paper 3 enters into the recess. So the paper 3 is then attached to the wall surface by electrostatic charges. Thereby, the paper 3 can quickly abut against the wall surface 11. In addition, in the second step, one surface of the paper 3 is coated with the waterproof material like edible wax or a PE film so as to form a waterproof film on the surface. When sending the paper 3 into the female mold 1, the surface with the waterproof film is away from the wall surface 11. Thereby, the inside surface of the paper container is formed by the surface coated with waterproof film. Preferably, two surfaces of the paper are both coated with waterproof film so as to achieve a better waterproof effect. Further, the injection hole 10 is preferably located near the gap 32, so the plastic material 4 can be efficiently and averagely injected into the gap 32. And the yield rate of plastic molding is thereby improved.

Besides, the annular trough 13 is annular disposed on the top periphery of the wall surface 11. When the mold is closed, the recess communicates with the gap 32, the injection space and the injection hole 10. The plastic material 4 is injected from the injection hole 10, and the plastic material 4 firstly flows into the injection space, and then fills up the gap 32. After that, the plastic material 4 flows through the annular trough 13. In this way, the plastic material 4 is molded in one piece at the bottom, the top periphery, and the gap of the paper container.

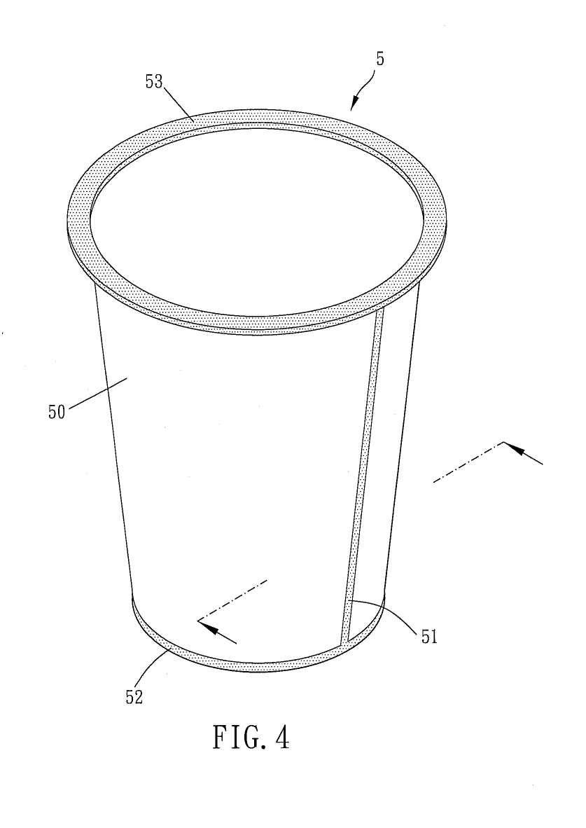

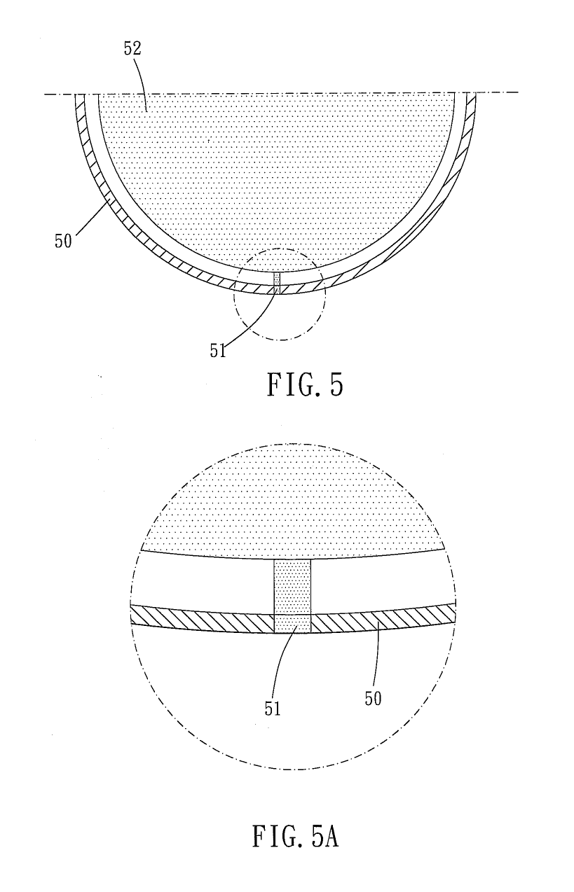

According to the above steps, the plastic material 4 can be molded to smoothly connect between the first end 30 and the second end 31 of the paper 3, so that a waterproof paper container is thereby obtained. Please refer to FIGS. 4 to 5A, the paper container 5 has an annular wall 50, a connecting portion 51, a bottom portion 52 and an annular portion 53. The annular wall 50 is curved to form as a loop and has two distal ends close to each other. The connecting portion 51 is smoothly and evenly connected between the two distal ends, as shown in FIG. 5A. The connecting portion 51 extends to a bottom of the annular wall 50 to form as the bottom portion 52 in one piece. The connecting portion 51 further extends to a top periphery of the annular wall 50 so as to form as the annular portion 53 in one piece. Thereby, a lid or film can evenly cover on the annular portion 53 so as to completely seal the opening of the paper container 5 without any slits.

To sum up, the paper container is formed by injecting plastic material between two distal ends of the paper so as to evenly and smoothly connect those two distal ends. As such, liquid is unable to touch the distal ends which are uncoated with waterproof film, and then the paper container is thereby waterproofed. The top periphery of the paper is also one-piece formed with the plastic material so as to form as the flat annular portion 53. The annular portion 53 can be covered and sealed with a lid or film without leakage. What's more, the plastic material 4 further extends to the bottom of the paper so as to form as the bottom portion 52 which seals the bottom of the paper container. In other words, the paper can be formed as a finished product in one processing time without any further processing. Therefore, the paper container of the present invention can be produced effectively and quickly.

What is claimed is:

1. A method of making a paper container, comprising the steps of:
preparing a mold, the mold comprising a female mold, a male mold, and an injection hole, the female mold having a recess and an annular trough, the recess having at least one wall surface and a bottom surface, the male mold being correspondingly formed with at least one side wall and a bottom wall, the annular trough being formed on a top periphery of the recess, the injection hole extending from one of the bottom surface and the bottom wall to an external space so as to communicate between the recess and the external space;
sending paper which is cut in a predetermined shape into the female mold, at least one surface of the paper being coated with a waterproof film, the paper having a first end and a second end, making the paper annularly abut against the wall surface, so that the first end and the second end are close to each other to form a gap between them;
closing the mold so as to make the paper abut against between the wall surface and the side wall, an injection space being defined between the bottom surface and the bottom wall, the injection space communicating between the gap and the injection hole, the gap communicating with the annular trough;
injecting plastic material into the injection hole, the plastic material filling up the injection space, flowing into the gap, and then flowing into the annular trough, so that the plastic material is connected between the first end and the second end; and
opening the mold to acquire the paper container.

2. The method of making a paper container of the claim 1, wherein the paper is electrified before sending into the female mold, so that the paper is then attached to the wall surface with electrostatic charges.

3. The method of making a paper container of the claim 1, wherein two surfaces of the paper are coated with a waterproof film.

4. The method of making a paper container of the claim 2, wherein two surfaces of the paper are coated with a waterproof film.

5. The method of making a paper container of the claim 1, wherein the injection hole is located near the gap.

6. A paper container being made by the method of claim 1, the paper container comprising an annular wall, a connecting portion, a bottom portion, and an annular portion, the annular wall being curved and having two distal ends which are close to each other, the connecting portion being smoothly connected between the two distal ends, the connecting portion extending to a bottom of the annular wall to form as the bottom portion in one piece, the connecting portion further extending to a top periphery of the annular wall so as to form as the annular portion in one piece.

7. A paper container being made by the method of claim 5, the paper container comprising an annular wall, a connecting portion, a bottom portion, and an annular portion, the annular wall being curved and having two distal ends which are close to each other, the connecting portion being smoothly connected between the two distal ends, the connecting portion extending to a bottom of the annular wall to form as the bottom portion in one piece, the connecting portion further extending to a top periphery of the annular wall so as to form as the annular portion in one piece.
